(19) United States
(12) Patent Application Publication
(10) Pub. No.: US 2004/0255917 A1
(43) Pub. Date: Dec. 23, 2004

(54) Impeller and a supercharger for an internal combustion engine

(76) Inventor: Peter G. Mokry, Toronto (CA)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/871,217

(22) Filed: Jun. 18, 2004

(30) Foreign Application Priority Data
Jun. 20, 2003 (CA) 2,432,831

(51) Int. Cl. F02B 33/00

(52) U.S. Cl. 123/559.1

(57) ABSTRACT

An impeller for a supercharger for an internal combustion engine and a supercharger incorporating such an impeller is disclosed. The impeller includes a molded upper part having a top wall defining a top opening. The top wall extends outwardly to a lateral edge and the top wall includes a plurality of vanes extending therefrom. The upper part is shaped to permit said upper part to be formed in a parting mold. A molded lower part is also provided which includes a bottom wall extending outwardly to a lateral side edge. The lower part has a plurality of radially extending vanes, and the lower part is shaped to permit said lower part to be formed in a parting mold. The upper and lower parts may be attached together to form a high speed molded impeller, which in turn is incorporated into a supercharger for an internal combustion engine.

### FIELD OF THE INVENTION

This invention relates generally to the field of internal combustion engines and more particularly to the field of automotive engines. Most particularly this invention relates to superchargers that are used to increase the performance of such engines.

### BACKGROUND OF THE INVENTION

Superchargers and turbochargers are well known devices for increasing the performance of internal combustion engines. These devices include an impeller to drive more air (and thus oxygen) into the combustion chamber to “boost” performance. The impeller is typically housed in a volute chamber which directs the air flow into the combustion engine. In general, the increase in pressure (and thus boost) is proportional to the tangential velocity of the impeller. A supercharger has an impeller that is typically about twice the size of the impeller of a turbocharger. The rotational speed of the supercharger impeller is typically between 45,000 and 60,000 rpm. Although generally more boost is better, for each engine there is an upper limit on the amount of boost that the engine can handle, so the rotational speed may be less than 45,000 RPM in some cases. It is very rare that the impeller speed would be more than 60,000 RPM.

Typically a turbocharger is run off a turbine which does not provide much torque. As a result, the impeller speeds for turbochargers are much higher than for superchargers to achieve the same performance level and can be in excess of 100,000 RPM. Since the tangential velocity is proportional to the amount of boost, the turbocharger impeller is typically about one half the size of a supercharger impeller (Vₜₐₙ=R*ω). The high speeds required for a turbocharger produce extreme stresses on the impeller, making the design and fabrication of the turbocharger impeller difficult and expensive. Likewise, to get the desired performance from a supercharger, the impeller is subjected to extreme stresses also making the design and fabrication of the impeller difficult and expensive as set out in more detail below.

A problem that persists with supercharger impellers however, is that they are difficult and expensive to manufacture. As such they are typically provided as after-market devices, and are not found as standard equipment on many mass produced (OEM) passenger automobiles. Each supercharger includes a high speed impeller which due to its intricate and complex shape is made by precision casting. In each case a model of the impeller must be first made out of wax or the like, then the casting mold (investment) is made by packing a refractory material such as sand around the wax model. Heat is applied to bake the mold and to melt the wax model allowing it to be drained from the mold. The molten metal is poured into the void to try to fill the void so formed in the refractory material. After the metal is permitted to cool, the refractory material can be removed from around the solid metal part. It is very difficult to generate economies of scale with this type of molding, since each molded impeller requires the same considerable investment of time and expertise. Since injection pressures of the molten metal are low there is also a tendency for voids to form in the molded part which renders the part unuseable.

A further problem of such a method of molding is that the molding accuracy is not high and yet for high speed impellers accuracy is highly desired. Clearly the faster the impeller rotates the more exaggerated and harmful any small imbalances in the impeller become. Thus, it is often necessary to finish the impeller, once removed from the mold. The impeller will need to be balanced, which is an expensive and labour intensive process, and may not be done adequately leading to problems in the use of the impeller. Essentially what is required is for the manufacturer to try to carefully remove selected material from the molded metal vanes to improve the rotational balance of the impeller from its originally cast state.

The advantage of this production technique is that the complex curves of the vanes can be molded as part of a single solid impeller. Due to the high speed of operation of such impellers a one piece impeller has in the past been believed to be necessary. The disadvantages of the production technique are that it is slow, labour intensive, not very accurate, and extremely expensive.

What is desired is a simple impeller design which can on the one hand withstand the high speed and high stress of the intended use and yet one which is simple, easy, and inexpensive to make, with a high degree of accuracy.

### SUMMARY OF THE INVENTION

The present invention is directed to a high speed impeller design for a supercharger as well as a supercharger incorporating such a high speed impeller design. According to the present invention the impeller can be mass produced for example by injection molding, which will greatly reduce the per piece cost of the final impeller. High injection pressures can be used reducing or eliminating voids and unuseable parts. In addition the injection molded impeller of the present invention will be made to fine tolerances, greatly reducing the time and cost associated with balancing the impeller prior to its high speed application.

The present invention is directed to a two part impeller which has certain features to permit a higher efficiency to be attained than in the prior art. Thus, according to the present invention the impeller can compress the same amount of air, into the combustion engine, while operating at a lower rotational speed due to such greater efficiencies. Essentially a more efficient impeller is better able to translate work into pressure. Alternatively the present invention can provide more compression if operating at higher speeds or the impeller may be smaller while rotating at the same speed and still deliver the same boost due to its greater efficiency. A smaller impeller is more easily positioned within an engine compartment and is therefore preferred.

Therefore according to one aspect of the present invention a two part impeller is disclosed in which each of the parts comprises a simple shape which is amenable to molding by means of a simple parting mold. Registration or interlocking features are provided between the two parts to ensure dimensional stability which is required under the high stresses due to the high rotational speeds of a typical supercharger.

According to another aspect of the invention the present invention includes a relatively flat surface, located on a plane generally perpendicular to the axis of rotation of the impeller onto which a seal can be formed. In this way the present invention prevents recirculating of the air thereby increasing the overall efficiency. In addition because the present invention comprehends a top wall, a bottom wall, and at least some vanes which extend fully therebetween, air which might otherwise pass over the vanes cannot do so. Both of these aspects improve the efficiency of the present impeller design over the prior art designs.

Therefore according to a first aspect of the present invention there is provided an impeller for a supercharger for an internal combustion engine, the impeller comprising:

a molded upper part having a top wall defining a top opening said top wall extending outwardly to a lateral edge, said top wall including a plurality of vanes extending therefrom, said upper part being shaped to permit said upper part to be formed in a parting mold; and

a molded lower part including bottom wall extending outwardly to a lateral side edge and having a plurality of radially extending vanes, said lower part being shaped to permit said lower part to be formed in a parting mold;

wherein the upper and lower parts may be attached together to form a high speed molded impeller.

In a further aspect of the present invention the two parts can be bonded together by, for example, a chemical bond such as glue, solder or other bonding agent.

### BRIEF DESCRIPTION OF THE DRAWINGS

Reference will now be made, by way of example only, to preferred embodiments of the present invention with reference to the attached figures in which:

FIG. 1 is a an exploded view of a two part high speed impeller according to the present invention;

FIG. 2 is a view of the two parts of the impeller of FIG. 1 attached together;

FIG. 3 is a top view of the impeller of FIGS. 1 and 2;

FIG. 4 is a top view of the impeller of FIG. 3 showing the location of the vanes with hidden lines;

FIG. 5 is a cross-sectional view along lines 5-5 of FIG. 4;

FIG. 6 is a cross-sectional view along lines 6-6 of FIG. 4;

FIG. 7 is a top view of a supercharger assembly according to the present invention;

FIG. 8 is a sectional view of the supercharger of FIG. 7 along lines 8-8; and

FIG. 9 is an exploded view of the supercharger assembly of FIG. 7 showing the arrangement of the parts thereof.

### DETAILED DESCRIPTION OF THE PREFERRED EMBODIMENTS

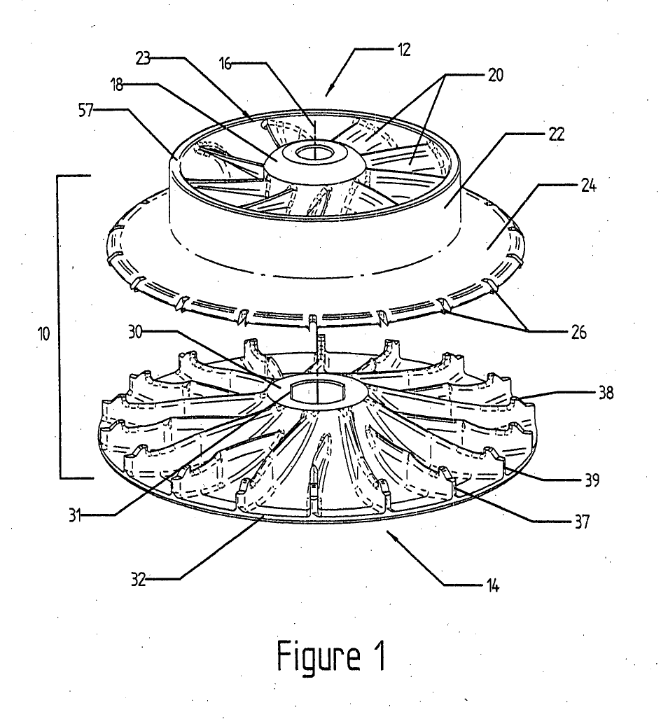

FIG. 1 shows an impeller generally indicated as 10, which is made up of a impeller top part 12 and a impeller bottom part 14. The two parts share a common axis 16. Each part 12 and 14 is described in more detail below.

The impeller top part 12 is a single molded part which includes a centre support 18, from which extend a plurality of vane portions 20. The vanes attach to a generally vertical wall 22, which rises up from a planar portion 24. The wall 22 defines an open top portion 23. A plurality of notches 26 are formed about the periphery of the planar portion 24.

The impeller lower part 14 also includes a centre support 30, and a bottom wall 32. The bottom wall 32 has extending upwardly from it a plurality of primary and secondary vane portions, each of which includes an upwardly extending finger 38. The vane portions 39 extend upwardly to the vane portions 20 to form a primary vane. Every other vane is preferably in the form of a half vane 37 as shown, which is independent from the vane portions 20 on the impeller top part 12 and may be called a secondary vane. Thus, in one embodiment of the invention, there are nine vane portions 20 and eighteen vane portions 37 and 39.

It can now be appreciated that each of the two parts 12 and 14 of the present invention can be made by injection molding in a simple parting type of mold. In particular the THIXOMOLDING (TM of Husky Injection Molding Inc.) technique may be used to form the two parts out of a metal which is both strong and lightweight. In this molding method metal alloy feedstock is introduced into the injection machine's barrel, like plastic resin. The metal is then heated to a semi-solid state rather than a superheated liquid state and is injected into a die under laminar rather than turbulent flow conditions. As a result the Thixomolded (TM of Husky Injection Molding Inc.) parts tend to have unique microstructures and can exhibit superior mechanical properties. Other forms of manufacturing are also comprehended such as die casting.

Most preferably the present invention is made from light weight magnesium alloy. This alloy is both lightweight and strong. As compared to convention aluminum or steel impellers, the present invention comprises an impeller having a lighter weight reducing inertial forces, therefore requiring less energy to power the impeller during acceleration. In addition, the strength to weight ratio of magnesium alloy is about 50% higher than forged steel thereby reducing centrifugal forces and thus giving greater flexibility in the design of the impeller. It will also be appreciated that an injection molded part can be produced in volume at a lower cost and with a higher degree of accuracy. Thus, the costly finishing and balancing of the prior art will be greatly reduced, if not eliminated. Other high strength moldable materials are also comprehended by the present invention, such as fiber-glass reinforced nylon.

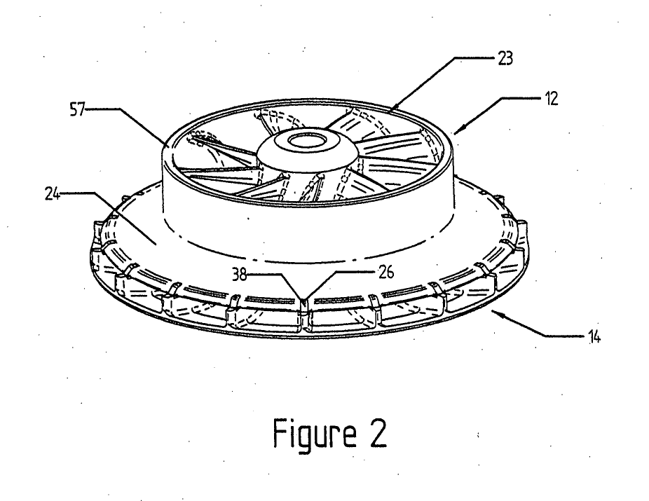

FIG. 2 shows the impeller top part 12 attached to the impeller lower part 14. As can be seen in the drawing, the fingers 38 register with the notches 26. In this sense the term register will be understood to mean that the fingers 38 interlock with the notches 26. In this way, the impeller lower part 14, which according to the present design is more structurally stable than the impeller top part 12, will help reinforce the impeller top part 12 which is less structurally stable at high rotational speeds. The present invention provides that the primary vanes in the assembled impeller are formed by the meeting of vane portions 20 extending down from the impeller top part 12 and vane portions 39 extending up from the impeller bottom part 14 (see FIG. 6). Thus, the top of the bottom part vane portions meet with and interlock with the bottom of the vane portions of the top part. A groove 41a is formed in cross section to improve the interlocking of the vane portions together. The present invention also provides that the secondary vane portions 37 interlock with a groove 41b formed in the planar portion 24 (see FIG. 5). Similarly the primary vane portions 39 of the impeller bottom part 14 also interlock with a groove (not shown) formed in the planar portion 24. As will be understood this improves the tortional rigidity of the impeller top part 12.

Various methods of attachment are comprehended by the present invention. In the preferred form the impeller top part 12 and the impeller lower part 14 are mounted onto a common axle. Most preferable the common axle includes one or more flat sides (shown as 31 in FIG. 1), and each of the upper and lower parts are formed with a matching axle opening so that the parts may be non-rotationally secured to the axle. In addition the lower part may be butted up against a shoulder and then a fastener is used to clamp down the upper part onto the lower part.

Other attaching means are also contemplated, including the use of a glue or epoxy between the two parts. The present invention comprehends other forms of bonding such as, welding, soldering or the like, as appropriate and depending on the choice and suitability of the materials. Thus when combined with a clamping force provided by a fastener and an adhesive or glue, the two parts can be securely held together. In this sense securely means that the two parts remain attached through the desired operating speeds of the impeller. As will be understood the grooves 41a and 41b provide more surface area for the adhesives to bond.

It can now be understood that when the impeller is rotating the air is drawn into the open top 23 and forced by the rotation of the vanes of the impeller between the top and bottom walls and then out the lateral side edges. The present impeller design therefore provides both a top wall consisting of a vertical wall 22 and the planar portion 24, and a bottom wall 32, to prevent air from recirculating or passing across the tops of the vanes as the vanes are rotated at speed. The use of both the top and bottom walls increase the mechanical and the isentropic efficiency of the present invention over the open faced impellers of the prior art. With a higher efficiency impeller the exit air temperature is lower which is beneficial for a combustion engine.

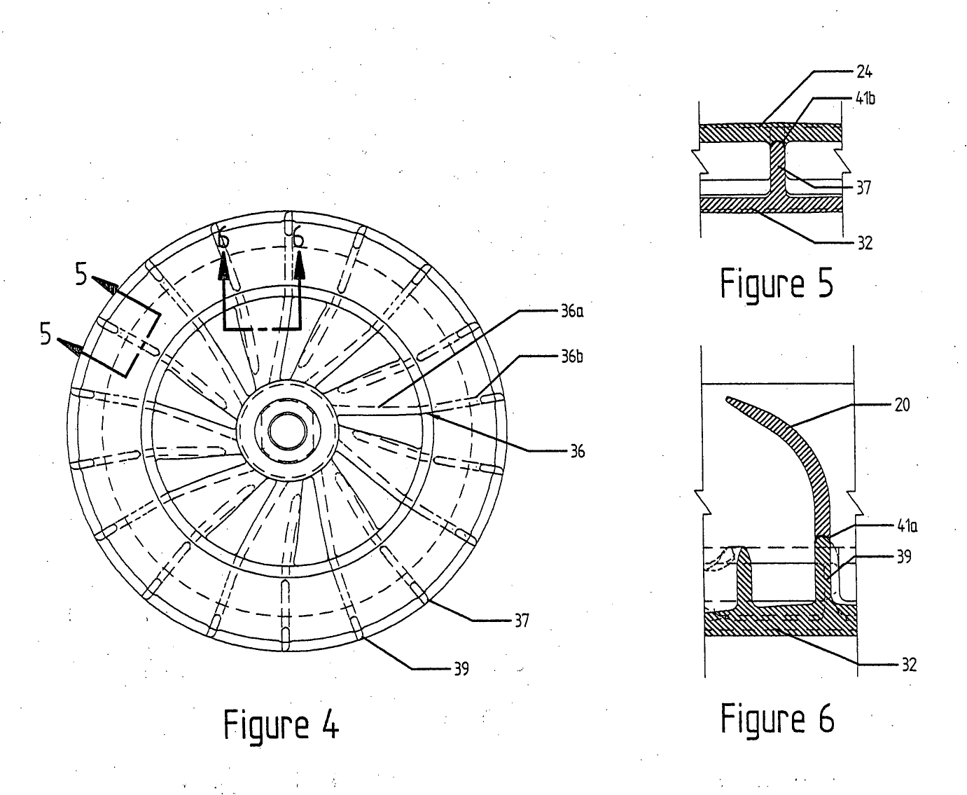

Another feature of the present invention is that the vanes, at the inlet end, have a negative rake angle as can be seen in FIG. 4. In this way the acceleration profile of the air past the vanes is somewhat more aerodynamically efficient, thereby improving the efficiency of the impeller design, when operating at high speeds. The improved design essentially reduces the shock to the incoming air as it is accelerated outward. The rake angle of the vanes requires additional strength however, as explained in more detail below.

The present invention also comprehends that, as the air approaches the outlet, the vanes are straightened to utilize the characteristics of a zero rake angle vane. Unlike the prior art, in which either a zero rake angle or a negative rake angle, but not both, is provided for the vanes, the present invention comprehends a smooth transition between the two rake angles from the inlet to the outlet of the impeller. The transition by the vanes from a negative rank angle to a zero rank angle provides pressure/flow characteristics suitable for an automobile application. This is clearly illustrated in FIG. 4 where the vane 36 is shown in top view. The rake angle changes between 36a and 36b as shown. As mentioned earlier, the grooves 41a and 41b help resist the tortional forces in the impeller top part 12, and ultimately the moment generated at high rotational speeds by the negatively raked vane portions 20 on the centre support 18.

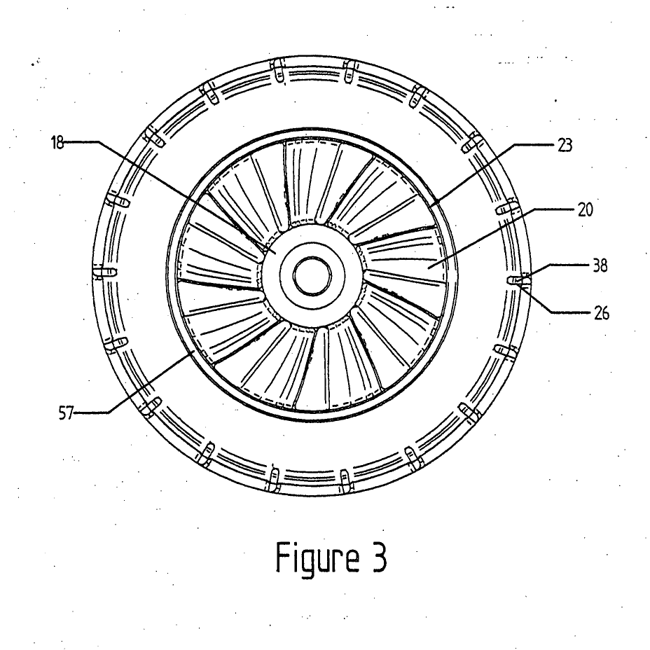

FIG. 3 is a top view of the impeller in FIG. 2. The open top 23 can be seen as well as the curved vanes (with the inlet negative rake angle) and a centre support 18. The fingers 38 registering in the notches 26 are also shown.

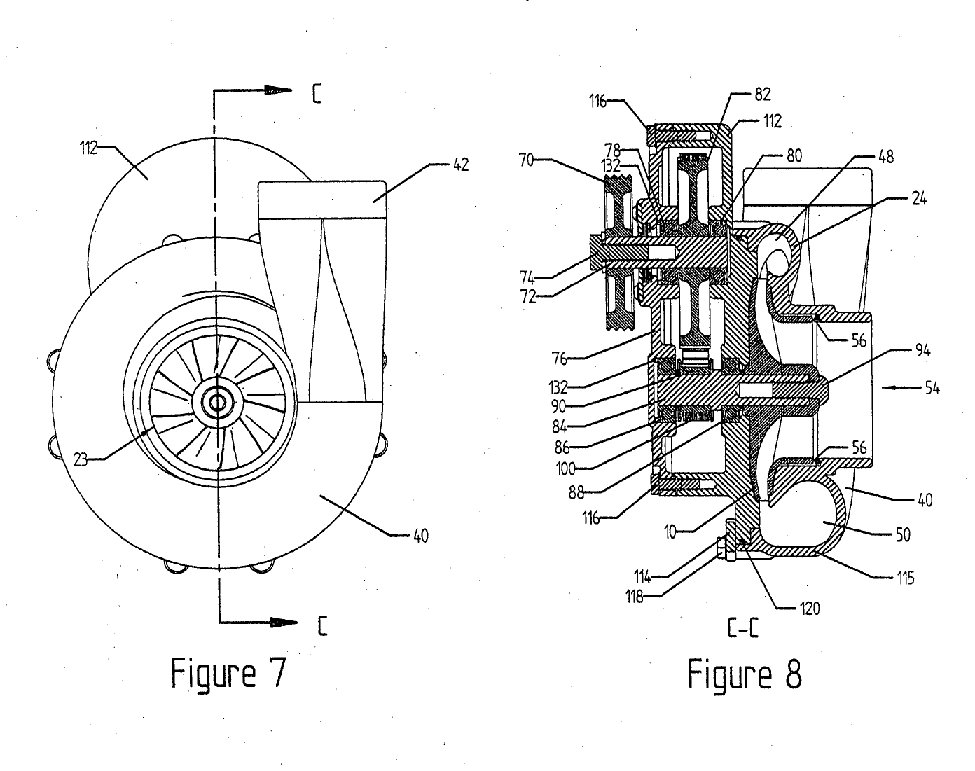

FIG. 7 shows the external view of an assembled supercharger according to the present invention, with the open top 23 and a volute chamber 40 and an exhaust manifold 42. The external drive train housing 112 for the impeller drive is also shown.

FIG. 8 shows the assembled supercharger in cross section. More specifically, the volute chamber 40 is shown having an increasing cross-sectional area, to accommodate an increasing volume of air between 48 and 50 as shown. An air inlet section 54 is shown which is about the same size as the open top 23 of the impeller. A seal 56 is also shown between the air inlet section 54 and the impeller. Most preferably the seal 56 is close to but not touching the impeller. In this sense close to means within about one to five thousands of an inch. This is an improvement over the prior art of typically about 25/1000 of an inch. In practice, due to slight imperfections or misalignments the gap may not be consistently one thousandth of an inch all about the periphery. Thus, while the present invention comprehends that a small gap exist between the surface of the o-ring seal and the impeller, it may also be that contact is made between the two when the impeller is operating at speed. Thus, the seal may be also referred to as a sliding seal. However, due to improved manufacturing tolerances due to the injection molding techniques, it is believed that the seal can be closely positioned to the impeller as taught. Although the seal can be mounted to either the impeller or the housing, being mounted to the housing is preferred. The seal improves the efficiency of the present invention over the prior art because it prevents air from recirculating.

It can be appreciated that an aspect of the present invention is to form a flat surface on the impeller against which the seal can be made. This flat surface is preferably closer to the axis of rotation so that small imperfections in the rotation of the impeller will have less effect on the position of the impeller during high speed rotation. Thus the most preferred location is to form the seal on the top wall adjacent to the top opening, and so the top edge of the top wall is designed to lie in a plane perpendicular to the axis of rotation. The top edge should be wide enough to form an effective sealing surface, most preferably about 2-3 mm. This is shown as 57 in FIGS. 1, 2, and 3. However the present invention comprehends that the seal could be made on any surface which lies on a plane perpendicular to the axis of rotation of the impeller. Thus, the seal could also be located, for example, along the top side of planar portion 24, towards the fingers. The molded planar portion of the present invention can be precisely formed to permit such a sealing surface to be reliably prepared and positioned. Another aspect of the present invention therefore is the design of the bottom wall which is such that the air moves down and then slightly up towards the outer edge of the impeller. In this way the present invention provides an additional flat sealing surface adjacent to the top outer edge of the impeller against which a further seal can be formed. Thus, the seal can be made at the top outer edge of the top opening or along the top side of the planar portion adjacent to an outer edge.

Turning to FIG. 8 there is shown in cross section the power train for the supercharger of the present invention.

Beginning at the left-hand side is an external drive pulley 70 which is mounted to an axle 72 by means of a threaded fastener 74. The axle 72 extends through the drive train housing cover 76 for the drive train and includes angular contact bearings 78 and 80. Located within the drive train housing cover 76 is a second drive pulley 82 attached to the axle 72.

Also shown is a second axle 84 with associated bearings 86, 88. A speed multiplying pulley 90 is attached to the second axle 84, which extends through the housing in an opposite direction to the axle 72. Attached to the distal end of the second axle 84 is the impeller 10. A threaded fastener 94 attaches the impeller to the second axle 84.

A drive belt 100 extends around the second drive pulley 82 and the speed multiplying pulley 90. Thus, as the external drive pulley 70 is rotated, through the drive train arrangement, the impeller is also rotated. Preferably the drive belt 100 is in the form of a timing belt, having positive registration features with each of the pulleys to prevent slipping. Alternatively, the drive belt 100 may be a chain or other form of secure belt, or other known drive such as helical gear, planetary gears or the like.

Most preferably, the arrangement of the present invention results in an impeller rotation of between 20,000 to 35,000 rpm. By sizing and shaping the impeller, the present invention can provide as much compression as less efficient impellers which are larger or which must rotate at higher speeds, such as 50,000 to 60,000 rpm. As will be appreciated by those skilled in the art, the ranges of rotational speeds set out above are approximate only and what is important is to deliver a pressure boost that is within the capacity of the engine to benefit therefrom. Since the boost is a function of rotation speed, impeller size and impeller efficiency, the advantages of a high efficiency impeller means that a slower speed can achieve the same compression. Also at slower speeds the stresses and strains on the impeller are reduced. This permits different materials to be used while having a higher performance and a longer service life.

It will be noted in FIG. 8 that the housing of the supercharger is comprised of a number of elements, namely, the drive train housing cover 76 for the drive train, a drive train housing 112, incorporating the bottom half of the volute chamber element and a separate top half 40 of the volute chamber. Each of the elements of the housing is secured to the adjacent element by appropriate fasteners such as threaded fasteners 116 and 118. A clamp element 114 can be used to permit some positioning flexibility. Also, an O-ring seal such as 120 is preferred to prevent high pressure air from leaking out of the volute chamber.

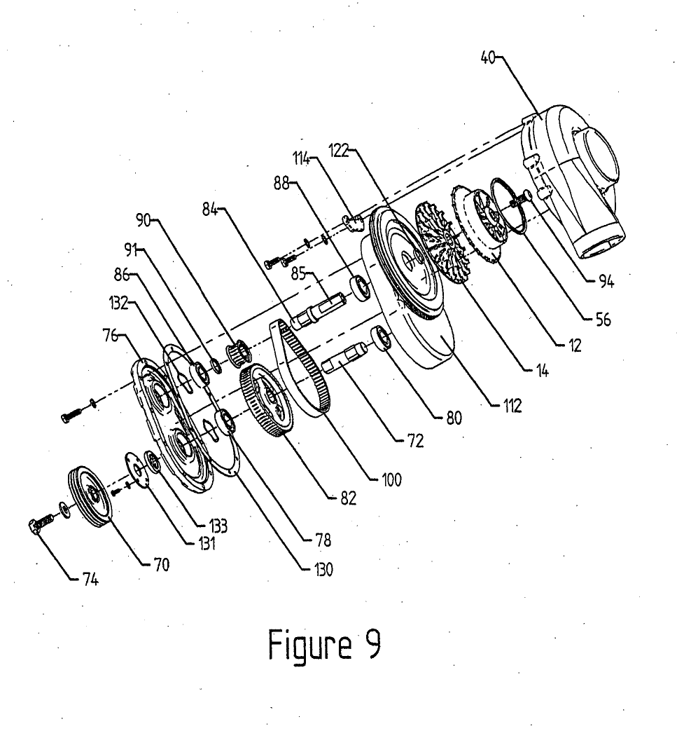

FIG. 9 shows in exploded view the components of the supercharger of the present invention in more detail. Beginning at the left-hand side, there is the volute chamber 40. The next element is the threaded fastener 94 which is used to attach the impeller top part 12 and the lower part 14 of the impeller together into the axle 84. Also shown is the seal 56 which seals the air gap around the open top 23 of the impeller top part 12. A spacer 122 is shown which sits between the impeller 10 and bearing 88. As noted, the axle 84 has opposed faces 85 to rotationally secure the axle 84 to the flat sides 31 of the impeller 10. Also shown are the axle 72, with bearings 78 and 80.

As shown the axle 84 fits into the speed multiplying pulley 90. A further spacer 91 and bearing 86 are shown inserted into the drive train housing cover 76. A gasket 130 is also shown. The toothed drive belt 100 is shown, which extends around the speed multiplying pulley 90 and the second drive pulley 82. On the outside of the supercharger, the threaded fastener 74 is shown attaching the external drive pulley 70 into place. A plate 131 is shown securing the shaft seal 133 to the drive train housing cover 76. Two circular wave springs 132 are used to preload the angular contact bearings. The preload helps seat the bearings as is known in the art.

It can now be appreciated how the present invention operates. In particular, external drive pulley 70 is attached to any external drive source located within the engine compartment. Typically, the pulley will be connected to the power steering or alternator drive belts. By means of the size differential between the second drive pulley 82 and the speed multiplying pulley 90, the rotational speed of axle 84 is much higher than axle 72. The multiplying factor is approximately from about 2.0-5.0 to 1 and most preferably about 3.5-4.0 to 1. In this way the impeller 10 can be rotated at a predetermined desired speed range. As will be appreciated by those skilled in the art, various pulley sizes can be used to achieve a change in rotational speed of the impeller as desired. However, good results have been obtained when the impeller rotates between 20,000 to 40,000 rpm.

It can further be appreciated that the present invention provides a high efficiency impeller which is less expensive to make than prior art designs. By making the impeller from a two part design, the present invention comprehends that the two impeller parts can be quickly, easily and accurately formed in a simple parting mold. Through accurate manufacture with closer tolerances as can be achieved with injection molding, and the use of a flat surface, an air seal can be formed to increase overall efficiency. Increased efficiency allows the same compression or boost to be generated at lower rotational speeds of the impeller. Lower speeds reduce the strains and stresses on the impeller, permitting the use of a two part impeller design. Registration or interlocking features, between the top part and the bottom part improve the vane strength in critical areas, as well as the rigidity and the durability of the design.

It will be appreciated by those skilled in the art that the foregoing description described preferred embodiments of the invention by way of example only and that the scope of the exclusive right or privilege afforded to this invention is defined by the appended claims. Various modifications and alterations are possible within the broad scope of the claims, some of which have been discussed above and others of which will be apparent to those skilled in the art. For example, there are a number of ways of attaching the upper and lower part of the impeller together, which still result in a secure attachment. Further, there are a number of ways of increasing the overall efficiency of the design, including using variable rake angles, using high tolerance production techniques, using an impeller design having a top and bottom wall to stop air from passing over the vanes, and using a seal to prevent air from recirculating.

1. An impeller for a supercharger for an internal combustion engine, the impeller comprising:
a molded upper part having a top wall defining a top opening said top wall extending outwardly to a lateral edge, said top wall including a plurality of vanes extending therefrom, said upper part being shaped to permit said upper part to be formed in a parting mold; and
a molded lower part including bottom wall extending outwardly to a lateral side edge and having a plurality of radially extending vanes, said lower part being shaped to permit said lower part to be formed in a parting mold;
wherein the upper and lower parts may be attached together to form a high speed molded impeller.

2. An impeller as claimed in claim 1 further including a sealing surface oriented on a plane perpendicular to an axis of rotation of said impeller.

3. An impeller as claimed in claim 2 wherein said sealing surface is located on a top surface of said top wall adjacent to said top opening.

4. An impeller as claimed in claim 2 wherein said sealing surface is located towards said lateral edge of said top wall.

5. An impeller as claimed in claim 1 wherein said vanes have a portion having a negative rake angle to improve dynamic air flow through said impeller.

6. An impeller as claimed in claim 1 wherein said vanes further including an outer portion having a zero rake angle to improve air pressure/flow characteristics when the impeller is in use over a range of different flow rates.

7. An impeller as claimed in claim 1 wherein said bottom wall is shaped to gradually rise towards a laterally outer edge.

8. A supercharger for an internal combustion engine comprising:
a drive means;
a housing including a volute chamber; and
a two part impeller, driven by said drive means located within said housing, said two part impeller having a molded lower part including a plurality of radially extending vanes, each of said vanes including a finger protrusion and a molded upper part having notches to accommodate said finger protrusions of said vanes.

9. A supercharger for an internal combustion engine as claimed in claim 8 wherein said drive means includes a drive train to increase the rotational speed between an input shaft and an output shaft.

10. A supercharger for an internal combustion engine as claimed in claim 8 further including a volute chamber sized and shaped to form an air seal when said supercharger is in use.

11. A supercharger for an internal combustion engine as claimed in claim 8 further including a seal to prevent air from recirculating.

12. An impeller for a supercharger for an internal combustion engine, the impeller comprising:
a molded upper part having a top wall defining top opening said top wall extending outwardly to a lateral edge, said later edge including a plurality of notches;
a plurality of vanes located in the top opening; and
a molded lower part including bottom wall having a plurality of radially extending vanes, each vane including a finger;
wherein the fingers of said lower part register the said notches of said upper part.

13. An impeller as claimed in claim 12 further including a sealing surface oriented on a plane perpendicular to an axis of rotation of said impeller.

14. An impeller as claimed in claim 13 wherein said sliding sealing surface is located on a top surface of said top wall adjacent to said top opening.

15. An impeller as claimed in claim 14 wherein said sliding sealing surface is located towards said lateral edge of said top wall.

16. An impeller as claimed in claim 15 wherein said vanes have a portion having a negative rake angle to improve air flow dynamics through said impeller.

17. An impeller as claimed in claim 16 wherein said vanes further including an outer portion having a zero rake angle.

18. An impeller as claimed in claim 17 wherein said bottom wall is shaped to gradually rise towards a laterally outer edge.
